(19) United States
(12) Patent Application Publication
(10) Pub. No.: US 2024/0360952 A1
(43) Pub. Date: Oct. 31, 2024

(54) Stand and A Portable Display Screen

(71) Applicant: Shenzhen Renmei Plastic Electronics Co., Ltd., Shenzhen (CN)

(72) Inventor: Huailu Wang, Shenzhen (CN)

(21) Appl. No.: 18/735,827

(22) Filed: Jun. 6, 2024

(30) Foreign Application Priority Data
Oct. 19, 2023 (CN) 2023228166197

(51) Int. Cl. F16M 13/00

(52) U.S. Cl. CPC F16M 13/005; G06F 1/166

(57) ABSTRACT

The present utility model discloses a stand and a portable display screen. Both ends of the stand body are internally provided with a rotating shaft. Both ends of the rotating shafts away from the stand body are provided with a rotating shaft hinge; Both rotating shaft hinges have a locking hole formed by bending; The rotating shafts are fitted into the locking holes, and the ends of the rotating shafts inserted into the stand body are key-axis-shaped. The stand body and display screen component are easy to install and can be fixed with screws, achieving a perfect combination. The material is lightweight and the flexibility of the rotating shafts can be changed by adjusting the screws. The stand body can meet users' requirements thanks to its high support stability and wide support angle range.

### FIELD OF THE UTILITY MODEL

The present utility model relates to an electronic product technology, in particular to a stand and a portable display screen.

### BACKGROUND

In the rapid developing era of the Internet, people always pay special attention to things online, however, the amount of information displayed on mobile phones is limited, and narrow phone sizes always have a significant negative impact on human vision. Therefore, portable displays with big screens are launched in the market, which can synchronously display an office computer and move tools.

For existing technologies, most portable displays are supported by leather sheath supports and independent stands. Leather sheath supports always cause bigger display sizes, higher display weights, unstable support and single viewing angles, while independent stands are always separated from bodies, making it inconvenient to carry, and causing damage to displays due to friction between stands and display surfaces.

### DESCRIPTION OF THE UTILITY MODEL

The present utility model provides a stand and a portable display screen to solve the issues involved in the background.

In order to solve the above issues, the present utility model provides the following technical solution: a stand and a portable display screen, including a stand body, wherein the stand body is U-shaped, and both ends of the stand body are internally provided with a rotating shaft. Both ends of the rotating shafts away from the stand body are provided with a rotating shaft hinge.

Furthermore, both the interiors of the rotating shaft hinges are formed by bending and provided with a locking hole, the rotating shafts are fitted into the locking holes and the ends of the rotating shafts inserted into the stand body are key-axis-shaped.

Furthermore, the rotating shaft hinges are made of stainless steel, and screws are threaded at both ends of the rotating shaft hinges to lock the rotating shafts.

Furthermore, both sides of the inner wall of the stand body are provided with a buckling block.

Furthermore, one side of the stand body has a skeleton groove.

Furthermore, it also comprises anti-slip rubber pads, wherein both rotating shaft hinges are provided with an anti-slip rubber pad on one side.

A portable display screen, including a display screen component and a stand.

Furthermore, the display screen component comprises a bottom shell, a surface shell set on one side of the bottom shell, and a display screen body set inside the bottom shell.

Furthermore, one side of the bottom shell has a folding slot, each rotating shaft hinge is fixed on one side of the inner wall of the bottom shell by screws; The ends of the rotating shafts away from the rotating shaft hinges extend to the interior of the folding slot, and the stand is rotationally fit into the folding slot by the rotating shafts; A buckling hole for fitting a buckling block is set on both sides of the inner wall of the folding slot.

Furthermore, a mainboard, a speaker and a keyboard are also provided inside the bottom shell, and anti-slip pads are used at the bottom of the bottom shell.

Compared with the prior art, the present utility model provides a stand and a portable display screen, the beneficial effects are that:

For the stand and portable display screen, the stand body and display screen component are easy to install and can be fixed with screws, achieving a perfect combination. The rotating shaft hinges are made of bent stainless steel without chemical anti-rust treatment, greatly simplifying the manufacturing process. The material is lightweight and the flexibility of the rotating shafts can be changed by adjusting the screws. The stand body can meet users' requirements thanks to its high support stability and wide support angle range. Its embedded design does not cause friction to the display screen component, and therefore it has broad application prospects.

### DESCRIPTION OF DRAWINGS

FIG. 1 shows a structure diagram of the stand body of the present utility model;

FIG. 2 shows a side view of the stand body of the present utility model;

FIG. 3 shows an exploded view of the stand body of the present utility model;

FIG. 4 shows a structure diagram of the display screen component and stand body of the present utility model;

FIG. 5 shows a schematic diagram of the present utility model when the rotating shaft hinges are not obscured by the anti-slip rubber pads;

FIG. 6 shows an exploded view of the display screen component of the present utility model;

FIG. 7 shows a schematic diagram of the combination of the display screen component and stand body of the present utility model.

Where: 1. Stand body; 2. Rotating shaft; 3. Rotating shaft hinge; 4. Locking hole; 5. Screw; 6. Buckling block; 7. Skeleton groove; 8. Anti-slip rubber pad; 9. Display screen component; 91. Bottom shell; 92. Surface shell; 93. Display screen body; 94. Folding slot; 941. Buckling hole; 95. Mainboard; 96. Speaker; 97. Keyboard; 98. Anti-slip pad.

### DETAILED DESCRIPTION OF THE PREFERRED EMBODIMENTS

With reference to the attached embodiment drawings of the present present utility model, the following will show a clear and complete description of a technical solution regarding the embodiments of the present utility model. It is obvious that the embodiment to be described refers to only a part of those of the present utility model. With reference to the embodiments of the present utility model, all other embodiments obtained by common technicians in the art without creative labor fall within the protection of the present utility model.

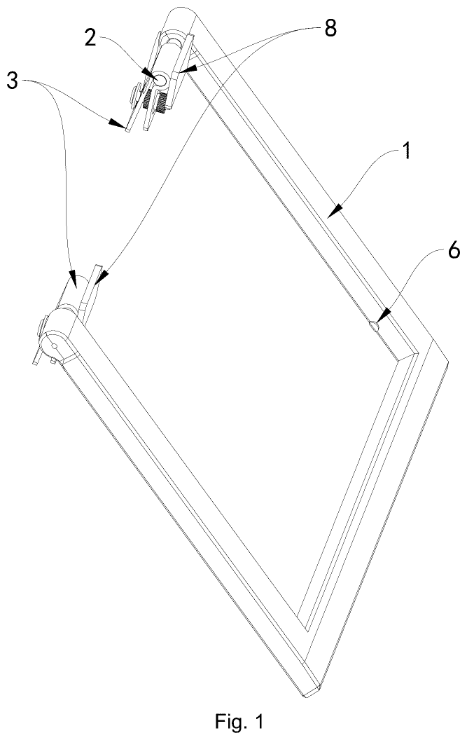

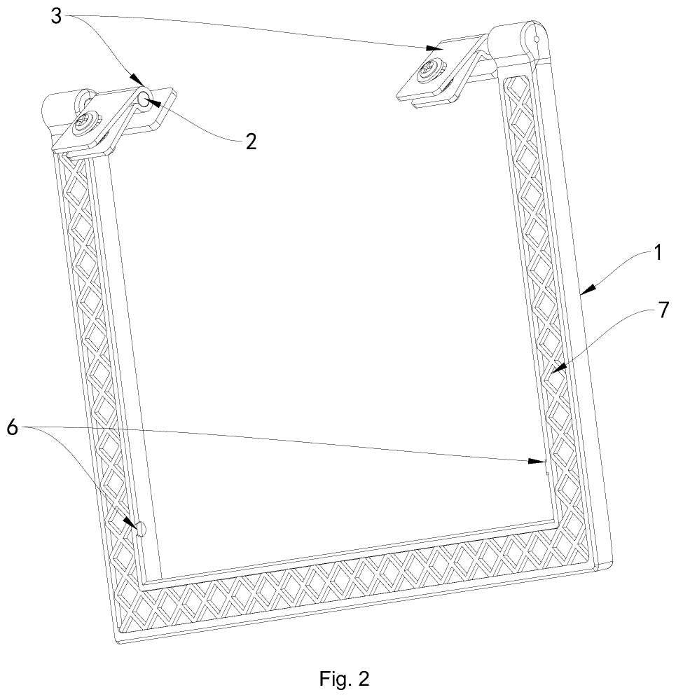

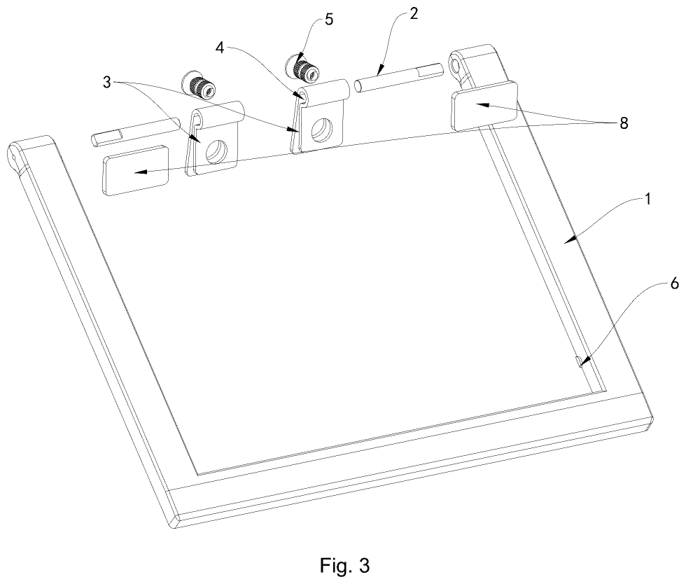

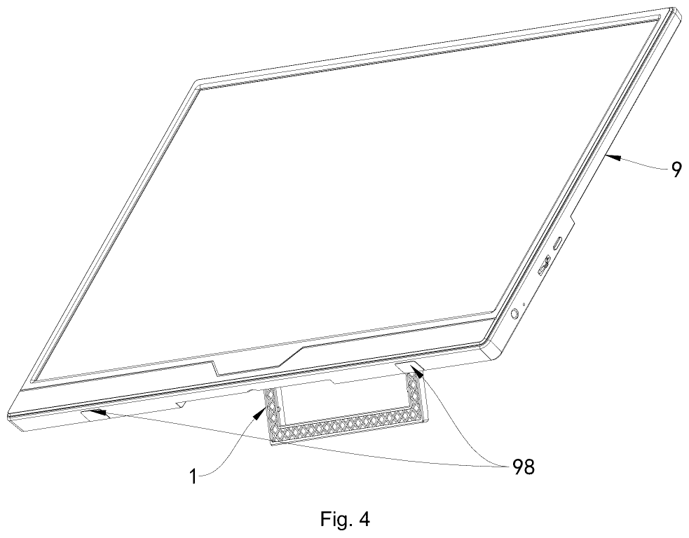

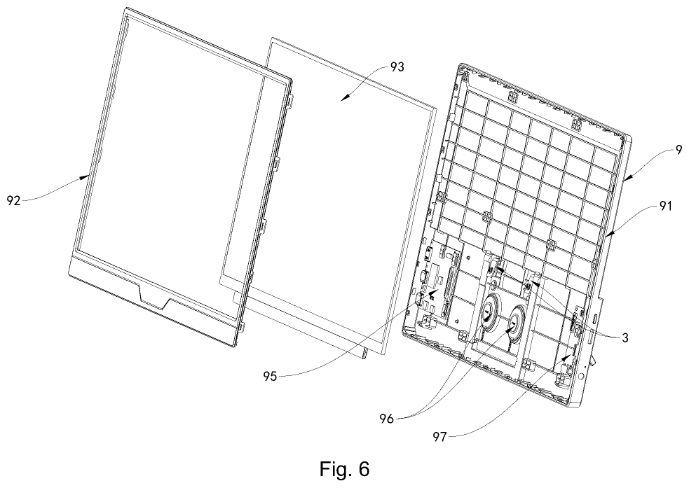

With reference to FIGS. 1-7, the present utility model discloses a stand and a portable display screen, which includes a stand body 1; The stand body 1 is U-shaped. Both ends of the stand body 1 are internally provided with a rotating shaft 2. Both ends of the rotating shafts 2 away from the stand body 1 are provided with a rotating shaft hinge 3; The stand body 1 is integrally formed with environmental-friendly plastic, and the stand body 1 and display screen component 9 are easy to install and can be fixed with screws 5, achieving a perfect combination with the display screen component 9. The rotating shaft hinges 3 are made of bent stainless steel without chemical anti-rust treatment, greatly simplifying the manufacturing process. The material is lightweight and the flexibility of the rotating shafts 2 can be changed by adjusting the screws 5. The stand body can meet users' requirements thanks to its high support stability and wide support angle range. Its embedded design does not cause friction to the display screen component 9, and therefore it has broad application prospects.

Specifically, both rotating shaft hinges 3 have a locking hole 4 formed by bending; The rotating shafts 2 are fitted into the locking holes 4, and the ends of the rotating shafts 2 inserted into the stand body 1 are key-axis-shaped. The rotating shaft hinges 3 are made of stainless steel and screws 5 are threaded at both ends of the rotating shaft hinges 3 to lock the rotating shafts 2; The rotating shafts 2 can be further locked by the locking holes by turning screws 5, making it convenient for users to adjust the damping strength when the rotating shaft 2 rotate. One end of both rotating shaft 2 is key-axis-shaped, which can ensure a more stable support when inserted into the stand body 1 and will not rotate in the stand body 1.

Specifically, both sides of the inner wall of the stand body 1 are provided with a buckling block 6, and one side of the stand body 1 has a skeleton groove 7; The use of buckling blocks 6 ensure the stability when folding the stand body 1, while the use of the skeleton groove 7 can help to reduce the processing materials of the stand body 1, lowering processing cost.

Specifically, it also comprises anti-slip rubber pads 8, wherein both rotating shaft hinges 3 are provided with an anti-slip rubber pad 8 on one side; The use of the anti-slip rubber pads 8 can ensure the stability of the display screen component when placed flat after folding the stand body 1, and help to cover the rotating shaft hinges 3 for keeping a more aesthetically pleasing appearance and easier future maintenance.

A portable display screen, including a display screen component 9 and a stand.

Specifically, the display screen component 9 comprises a bottom shell 91, a surface shell 92 set on one side of the bottom shell 91, and a display screen body 93 set inside the bottom shell 91.

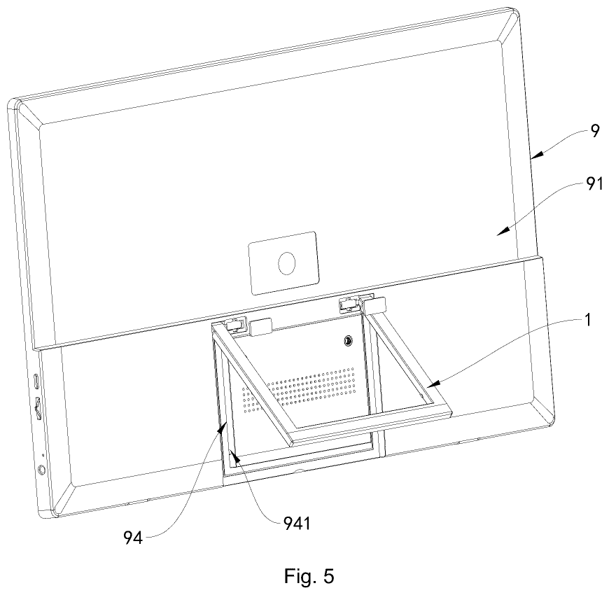

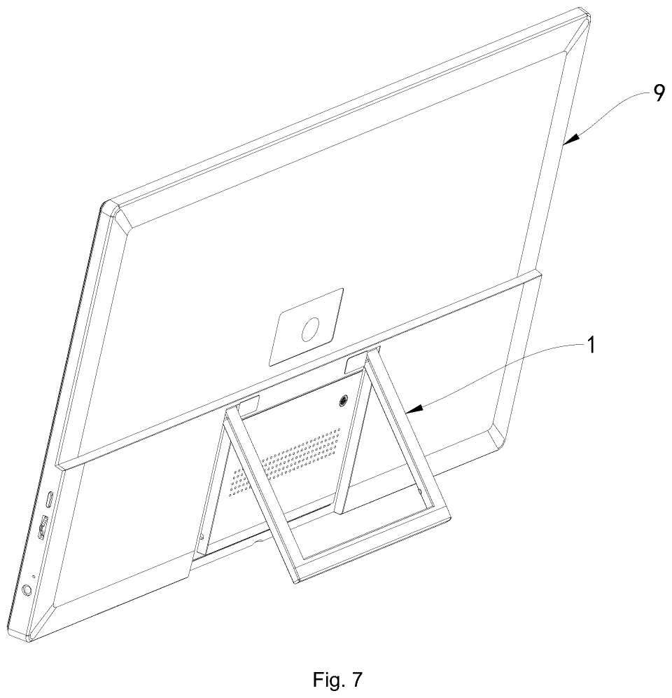

Specifically, one side of the bottom shell 91 has a folding slot 94, each rotating shaft hinge 3 is fixed on one side of the inner wall of the bottom shell 91 by screws 5; The ends of the rotating shafts 2 away from the rotating shaft hinges 3 extend to the interior of the folding slot 94, and the stand is rotationally fit into the folding slot 94 by the rotating shafts 2; A buckling hole 941 for fitting a buckling block 6 is set on both sides of the inner wall of the folding slot 94; According to FIGS. 5 and 7, the folding slot 94 has the same shape as the stand body 1, so that the aesthetic of the display screen component 9 does not change after folding the stand body 1; The buckling blocks 6 are buckled in the buckling holes 941 after folding the stand body 1, ensuring the stability of the stand body 1 when folded.

Specifically, a mainboard 95, a speaker 96 and a keyboard 97 are also provided inside the bottom shell 91, and anti-slip pads 98 are used at the bottom of the bottom shell 9; The mainboard 95, speaker 96, and keyboard 97 are all common parts that form the display component 9; The use of the anti-slip pads 98 ensures the stability of the display component 9 when supported.

In summary, for this stand and portable display screen, the stand body 1 and display screen component 9 are easy to install and can be fixed with screws 5, achieving a perfect combination with the screen component 9. The rotating shaft hinges 3 are made of bent stainless steel without chemical anti-rust treatment, greatly simplifying the manufacturing process. The material is lightweight and the flexibility of the rotating shafts 2 can be changed by adjusting the screws 5. The stand body can meet users' requirements thanks to its high support stability and wide support angle range. Its embedded design does not cause friction to the display screen component 9, and therefore it has broad application prospects.

Although embodiments of the present utility model have been shown and described, it can be understood by those skilled in the art that changes, modifications, substitutions, and variations can be made to these embodiments within the principle and spirit of the present utility model. The scope of the present utility model is dependent on the relevant claims and their equivalents.

1. A stand comprising a stand body (1), which is characterized in that: the stand body (1) is U-shaped, and both ends of the stand body (1) are internally provided with a rotating shaft (2), and both ends of the rotating shafts (2) away from the stand body (1) are provided with a rotating shaft hinge (3).

2. The stand according to claim 1, which is characterized in that: Both the interiors of the rotating shaft hinges (3) are formed by bending and provided with a locking hole (4), the rotating shafts (2) are fitted into the locking holes (4) and the ends of the rotating shafts (2) inserted into the stand body (1) are key-axis-shaped.

3. The stand according to claim 1, which is characterized in that: The rotating shaft hinges (3) are made of stainless steel, and screws (5) are threaded at both ends of the rotating shaft hinges (3) to lock the rotating shafts (2).

4. The stand according to claim 1, which is characterized in that: Both sides of the inner wall of the stand body (1) are provided with a buckling block (6).

5. The stand according to claim 1, which is characterized in that: One side of the stand body (1) has a skeleton groove (7).

6. The stand according to claim 1, which is characterized in that: It also comprises anti-slip rubber pads (8), wherein both rotating shaft hinges (3) are provided with an anti-slip rubber pad (8) on one side.

7. A portable display screen, which is characterized in that: It comprises a display screen component (9) and a stand as claimed in claim 1.

8. The stand according to claim 7, which is characterized in that: The display screen component (9) comprises a bottom shell (91), a surface shell (92) set on one side of the bottom shell (91), and a display screen body (93) set inside the bottom shell (91).

9. The stand according to claim 8, which is characterized in that: One side of the bottom shell (91) has a folding slot (94), each rotating shaft hinge (3) is fixed on one side of the inner wall of the bottom shell (91) by screws (5); The ends of the rotating shafts (2) away from the rotating shaft hinges (3) extend to the interior of the folding slot (94), and the stand is rotationally fit into the folding slot (94) by the rotating shafts (2); A buckling hole (941) for fitting a buckling block (6) is set on both sides of the inner wall of the folding slot (94).

10. The stand according to claim 9, which is characterized in that: A mainboard (95), a speaker (96) and a keyboard (97) are also provided inside the bottom shell (91), and anti-slip pads (98) are used at the bottom of the bottom shell (91).
